(19) United States
(12) Patent Application Publication
(10) Pub. No.: US 2006/0021474 A1
(43) Pub. Date: Feb. 2, 2006

(54) Double headed striking tool

(76) Inventor: Michael Burgess, Oshawa (CA)

Correspondence Address: DIMOCK STRATTON LLP, 20 QUEEN STREET WEST SUITE 3202, BOX 102, TORONTO, ON, M5H 3R3, CA

(21) Appl. No.: 10/900,128

(22) Filed: Jul. 28, 2004

(51) Int. Cl. B25D 1/00; B25D 1/14

(52) U.S. Cl. 81/26; 81/20

(57) ABSTRACT

A double-headed striking tool is provided with a first and second head of approximately equal mass mounted at opposing ends of a handle such that the first and second head are aligned at a right angle to each other. The handle is shaped to provide an aligned grip with an expanded or flared midsection that tapers to a smaller cross-sectional area at the opposing ends. The first and second head may be formed with a crown or bevelled strike face and a curved or straight claw. A carrier for a double-headed striking tool comprises a keyhole-shaped receptacle for inserting the strike face of the tool, and suspending the tool by its neck.

### FIELD OF THE INVENTION

This device relates generally to hand tools and, more particularly, to striking tools.

### BACKGROUND OF THE INVENTION

Striking tools are a category of hand tools used in construction, carpentry, and other fields, which leverage force in order to deal a blow to a target, such as a fastener head or a working surface. This class of hand tools is dominated by the hammer.

Hammers comprise a head with at least one face intended for striking the target or working surface, mounted on a generally cylindrical handle such that the axis of the hammer head is generally perpendicular to the axis of the handle. The head is typically formed of metal or other sufficiently rigid or resilient material, and is shaped according to its intended application: nail hammers and rip hammers, for example, are used for carpentry, and are provided with a head with a striking face at a first end, and a two-pronged claw at a second end for drawing nails. A mallet has a generally cylindrical head with two striking faces for use in upholstery and furniture assembly, and other uses where it is desirable to avoid marking the working surface. Ball pein hammers are used for riveting and shaping soft metal, having a generally circular, flat striking face at a first end of the head, and a hemispherical striking face at a second end for shaping metal. Other hammers have been developed to suit other tasks and working materials. A single project, incorporating different stages of construction and finishing as well as different materials, may thus require the use of more than one hammer as well as other hand tools.

The hammer handle is preferably manufactured from wood, as it is considered to be superior to other materials in dampening the reverberations travelling from the head to the handle once a blow has been dealt with the hammer head. The handle itself is often contoured to accommodate the user's grip, and may be cushioned or padded in order to reduce the effect of vibration on the user's hand. However, the user may still experience physical stress due to the impact between the head and the work surface.

Moreover, because users are generally advised to grip the hammer handle loosely in order to reduce the vibrations felt through the hand and wrist, safety in inclement weather conditions is a concern. Because the hammer handle is generally cylindrical, the handle may slip through the user's grasp. Some handles are accordingly prevented with a wrist tether to add some measure of security.

The generally cylindrical shape of the hammer handle does not permit the user to quickly acquire a positive, aligned grip, which may result in glancing blows on the target, or over- or under-estimating the distance between the user's hand and the target (overstrike and understrike). Consequently, users attempting to drive a fastener into a surface are sometimes advised to choke up on a longer-handled hammer for the first blow, which establishes the position of the fastener by causing the fastener to shallowly penetrate the surface, and then to reposition their grip towards the end of the handle in order to deliver further blows with greater momentum. However, changing the grip reduces the accuracy of further blows, as the user's visual estimate of the distance between the hand gripping the hammer and the point of impact is no longer correct. In attempting to compensate for the change in distance, the user may overstrike the intended target. Overstriking may result in the hammer handle impacting the fastener head, potentially damaging the handle and rendering the tool unsafe for further use.

Furthermore, the irregular shape of a hammer restricts the possible means by which a hammer may be carried by a worker while leaving the hands free. A solution to this problem has been to provide a loop on a belt or an item of clothing, large enough to receive the hammer handle but small enough to prevent the hammer head from passing therethrough. When such a carrying means is used, the user must use both hands to retrieve the hammer and jockey it into a working grip; first, the hammer must be grasped by the head with a first hand, then gripped by the handle using the second hand. Attempting to jockey the hammer into position using only one hand, by choking up the hammer from the head to the handle while throwing the hammer upwards, is potentially dangerous as the worker may lose control of the hammer.

It is therefore desirable to provide an improved striking tool that provides multiple striking faces and increased comfort and accuracy to the user. It is also desirable to provide an efficient carrier for such a striking tool.

### SUMMARY OF THE INVENTION

According to an aspect of the invention there is provided a double-headed tool. As an example of a preferred embodiment, the tool is provided with a handle having an axis, a first head mounted to a first end of the handle, and a second head having substantially the same mass as the first head, opposedly mounted to a second end of the handle at a substantially right angle to the first head in a plane perpendicular to the axis of the handle.

In a further aspect of the invention, the first end and the second end of the handle have substantially the same cross-sectional area, and the midpoint of the handle has a cross-sectional area greater than the cross-sectional area of either the first or second end. As an example of the preferred embodiment, the first end and the second end each have a cross-section defined by a longer dimension and a shorter dimension, such as a rectangle, such that the longer dimension of the first end of the handle is at a substantially right angle to the longer dimension of the second end, and the midpoint of the handle has a substantially square cross-section.

A further aspect of the tool is that at least one of the first head and the second head is provided with a strike face, and further that at least one of the heads is provided with a claw. In another aspect, each head of the tool is provided with two opposedly-facing strike faces, or two opposedly-facing claws.

In yet a further aspect of the tool, at least one of the first head and the second head is provided with an engagement surface for engaging a grip while the other of the first head and second head is used for striking.

Another aspect provides a carrier for a striking tool having a strike face with a first predetermined dimension and a neck having a second, smaller, predetermined dimension, for mounting on a harness or belt. The carrier has a plate member, a first receptacle formed within the plate member sized for receiving the strike face, and a second receptacle formed within the plate member, in communication with the first receptacle, sized for receiving the neck. The carrier may be provided with a backing plate.

### BRIEF DESCRIPTION OF THE DRAWINGS

In drawings which illustrate by way of example only a preferred embodiment of the invention,

FIG. 1 is a perspective view of a double-headed striking tool;

FIGS. 2a and 2b are plan views of the double-headed striking tool of FIG. 1;

FIG. 3 is a side elevation of a handle of a double-headed striking tool;

FIGS. 4a, 4b, and 4c are cross-sectional profiles of the handle of FIG. 3;

FIGS. 5a, 5b, and 5c are cross-sectional profiles of a further embodiment of the handle of FIG. 3;

FIG. 6 is a perspective view of a further embodiment of the double-headed striking tool;

FIG. 7 is a plan view of a carrier for a striking tool;

FIG. 8 is a side elevation of the carrier of FIG. 7, with a preferred embodiment of the tool of FIG. 1 shown in phantom lines;

FIG. 9 is a perspective view of a striking grip on the double-headed striking tool of FIG. 1;

FIGS. 9a, 9b, and 9c are perspective views of a grasping action on the tool of FIG. 1;

FIG. 10 is a perspective view of a horizontal striking grip on the double-headed striking tool of FIG. 1;

FIG. 11 is a perspective view of a leveraging grip on the double-headed striking tool of FIG. 1;

FIG. 12 is a perspective view of the double-headed striking tool of FIG. 1 supporting a panel;

FIG. 13 is a perspective view of the double-headed striking tool of FIG. 1 employed as a stud straightening tool;

FIG. 14 is a perspective view of the double-headed striking tool of FIG. 1 employed as a carrying aid;

FIGS. 15a, 15b, and 15c are perspective views of the double-headed striking tool of FIG. 1 employed as a leveraging tool.

### DETAILED DESCRIPTION OF THE INVENTION

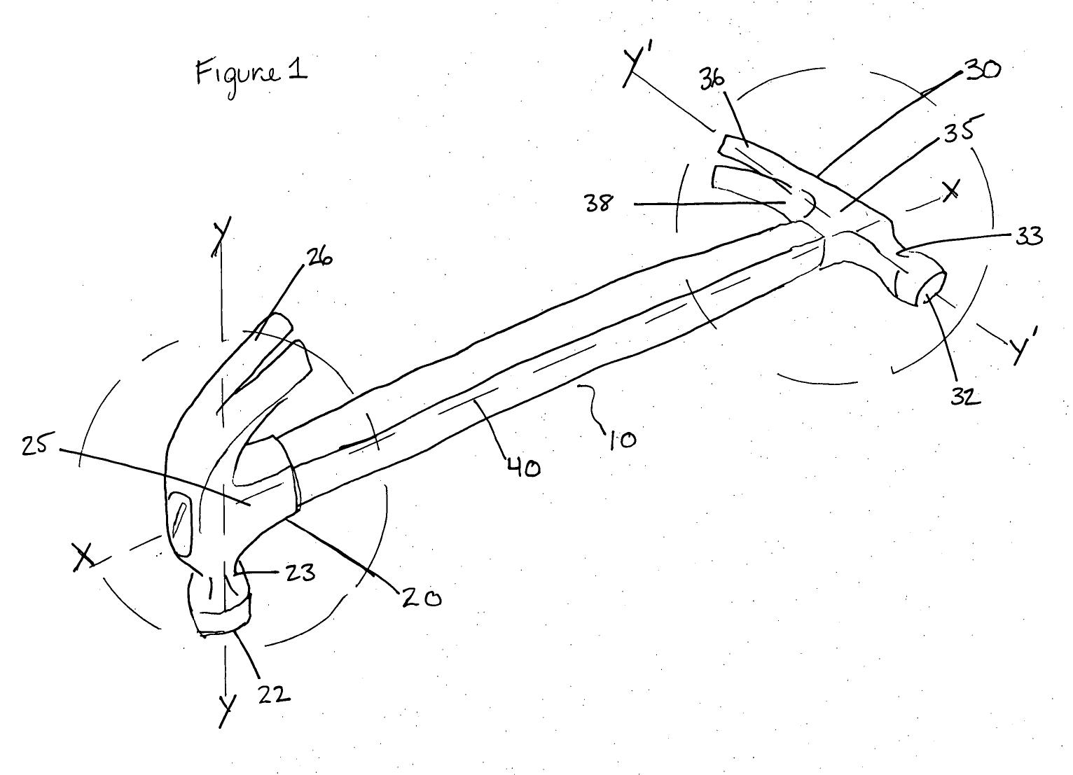

As shown in FIG. 1, a preferred embodiment of the striking tool 10 as a double-headed hammer comprises a handle 40 with an axis x connecting a first head 20 and a second head 30. In the most preferred embodiment, the first head 20 is a claw-type hammer head, with a strike face 22 on a neck 23 at a first face of the head and a two-pronged claw 26 on an opposing second end of the head, the two ends being connected by a cheek 25. The strike face 22 may have a crown edge or a flush edge at the intersection between the face 22 and the neck 23. The head 20 is mounted on the handle 40 by means known in the prior art, such that the longitudinal axis y of the head 20 is perpendicular to the axis x of the handle 40. The second head 30 is also a claw-type hammer head, although preferably provided with a differently-shaped claw; for example, one of the two heads 20, 30 may be a rip claw hammer head, while the remaining head is a curved claw head.

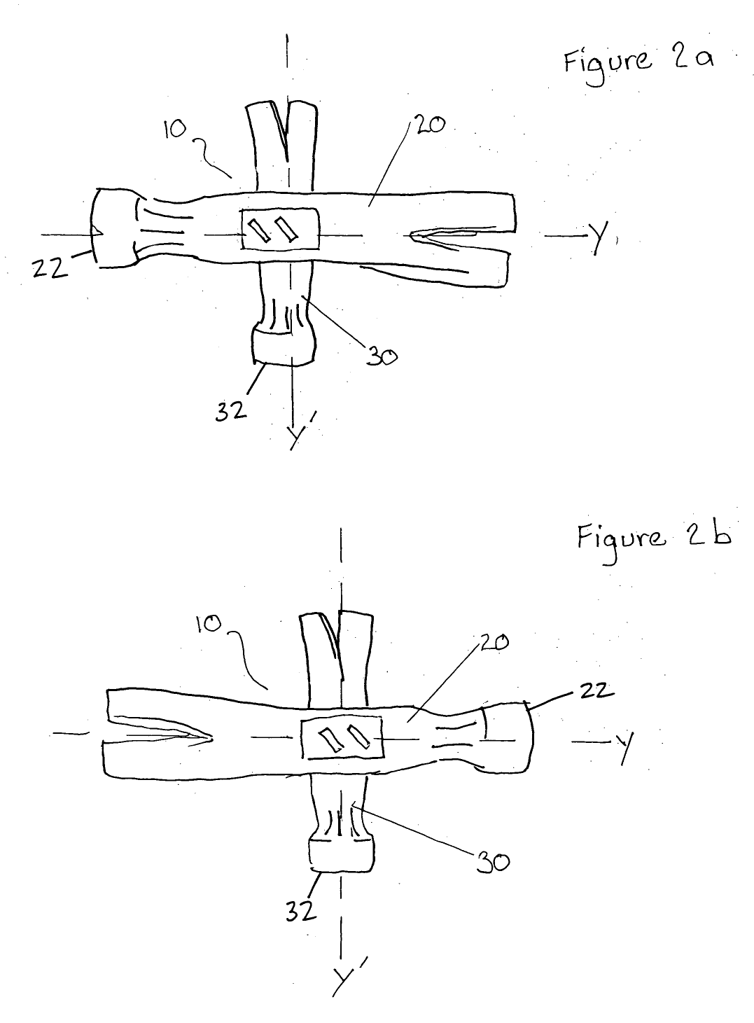

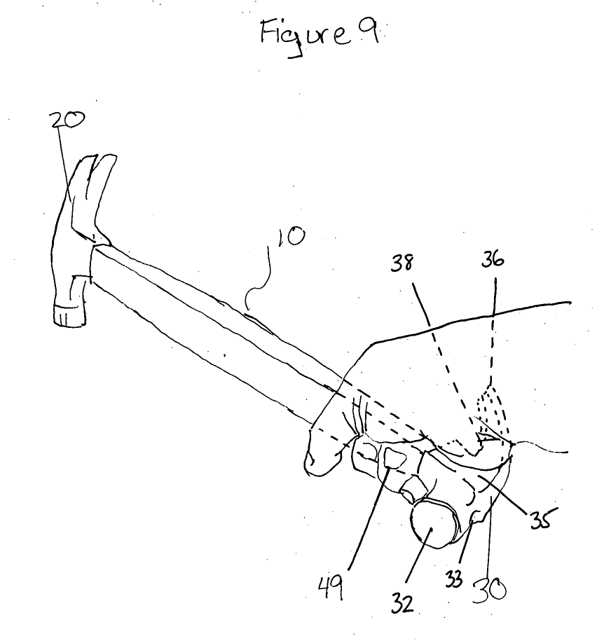

The second head 30 is mounted on the handle 40 by means known in the prior art; however, unlike the prior art, the second head is mounted on the handle 40 such that the longitudinal axis y′ of the second head 30 is at a substantially right angle to the axis y of the first head 20. The two heads, 20 and 30, have substantially the same mass. The heads 20, 30 may be formed of tempered steel, although a person skilled in the art will appreciate that the composition of the heads will vary according to the hammer's intended use. When heads having two different opposing ends are mounted on the handle 40 with their longitudinal axes y, y′ aligned at a right angle in the plane perpendicular to the handle axis x, the second head 30 may be mounted such that it is rotated ninety degrees either clockwise or counter-clockwise around the axis x, as shown in FIGS. 2a and 2b, respectively. As will be appreciated from the description below, a double-headed striking tool 10 wherein the heads are aligned as shown in FIG. 2a is a preferred embodiment for a right-handed grip, and the alignment of FIG. 2b is a preferred embodiment for a left-handed grip. If one of the heads 20 or 30 is provided with opposing, symmetric faces, such as the mallet head 20 shown in FIG. 6, it will be appreciated by those skilled in the art that the relative direction of rotation of the heads 20, 30 is irrelevant to a right-handed or left-handed grip.

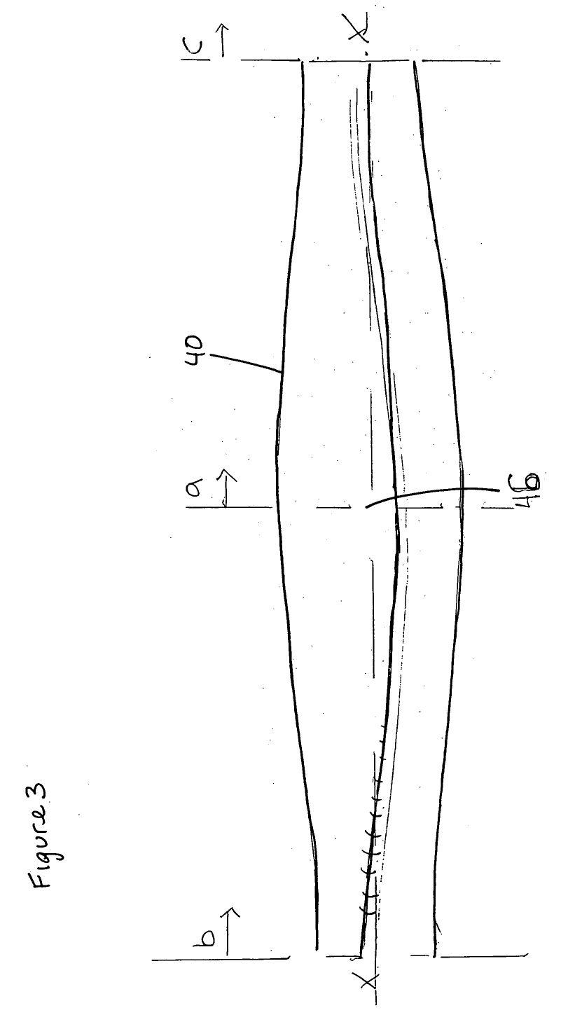

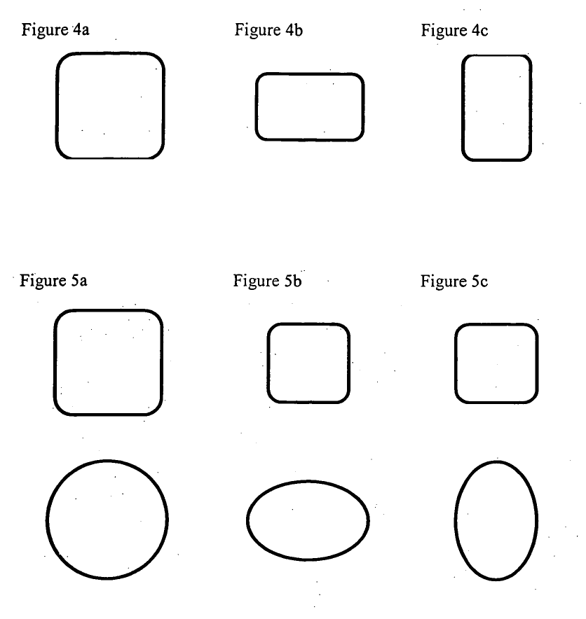

Referring to FIG. 3, in a preferred embodiment of the handle 40, the cross-sectional profile of the handle varies with the distance from the midpoint 46 of the handle 40. Preferably, the handle has a generally square profile, and the greatest cross-sectional area, at the midpoint 46, and as shown in FIG. 4b; the handle tapers in both directions towards the heads 20, 30 to a substantially rectangular cross-section as shown in FIGS. 4a, 4c. As the heads 20, 30 are at substantially right angles to each other, the rectangular profiles of the handle 4a, 4c are correspondingly aligned at a right angle as well. For comfort, the edges of the square or rectangular profile are preferably rounded or bevelled.

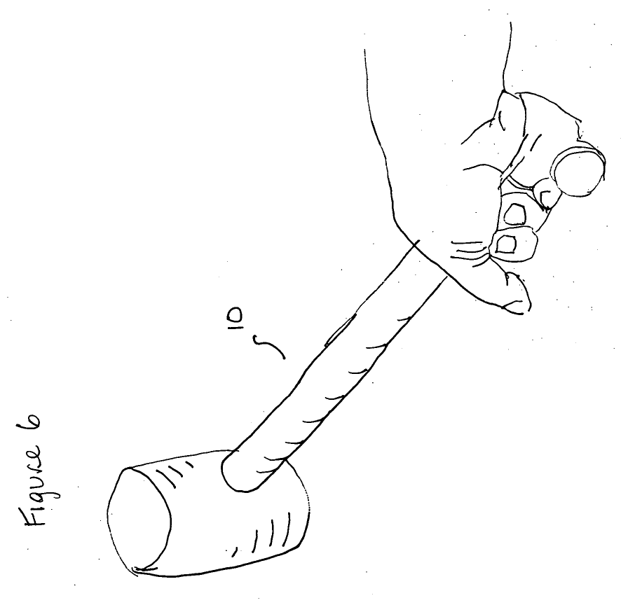

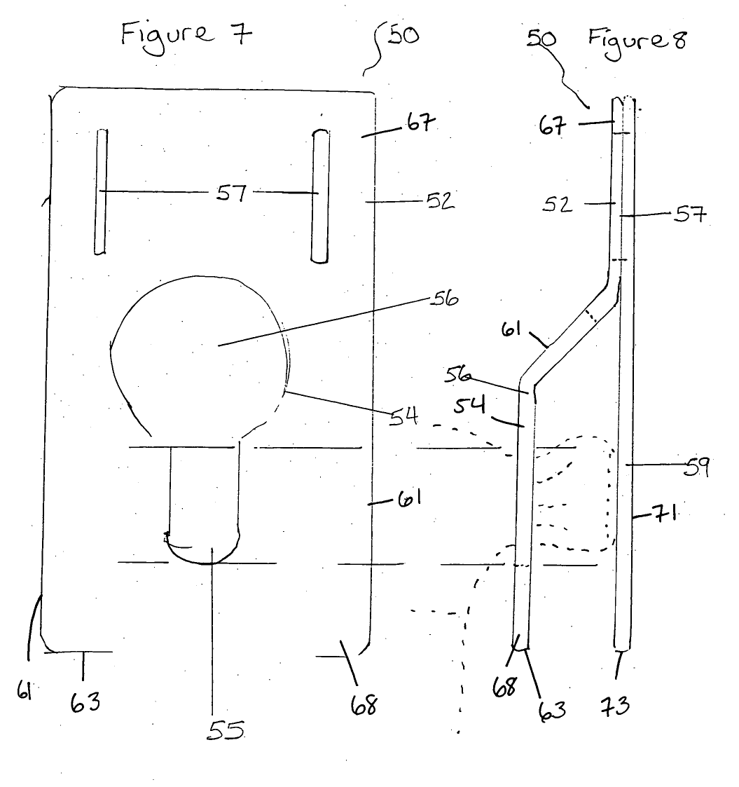

In other, less preferred, embodiments, the profile of the handle may be consistently square, or range between circular and oblong, as shown in FIGS. 5a, 5b, and 5c. It can be seen with reference to FIGS. 4a, 4c, and the oblong profiles of FIGS. 5a, 5c, that in a preferred embodiment, the handle profile has longer and shorter dimensions, aligned such that the longer dimension is substantially parallel to the longitudinal axis y, y′ of the head 20 or 30.

The length of the handle 40 may depend according to the intended use of the tool 10, or the weight of the heads 20, 30; however, if the handle is manufactured to a standard length, such as sixteen inches, the handle may be used to estimate distances when approximate measurements are appropriate.

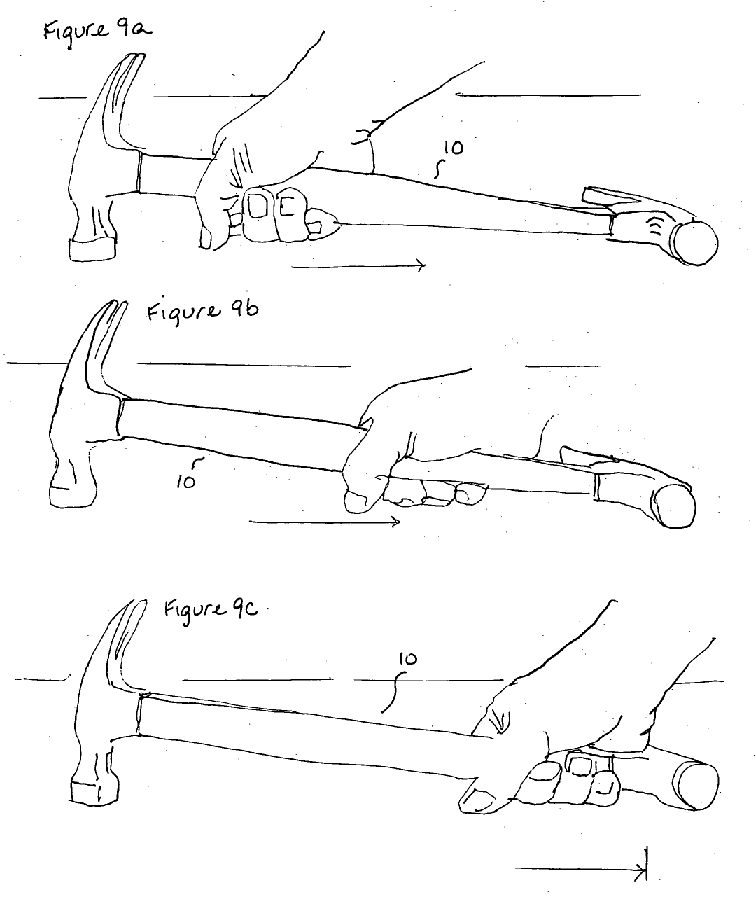

A carrier 50 is provided for transporting a double-headed striking tool 10, such as that shown in FIG. 1. Referring to FIGS. 7 and 8, the carrier 50 comprises a plate 52 with a keyhole-shaped aperture 54, comprising a slot portion 55 and an expanded portion 56. The expanded portion 56 is sized to admit the end of the head 20 or 30 bearing the strike face 22; the slot portion 55 is sized to be narrower than the expanded portion 56, but is sufficiently large to admit the neck 23. The plate 52 is preferably shaped, as shown in FIG. 8, with a curvature, bend, or joint in the midsection of the plate 52 such that the upper portion 67 is substantially parallel to, but set back from, the lower portion 68 in order to facilitate use of the carrier 50 when worn on the body. Most preferably, a backing 59 is mounted to the plate 52. In further embodiments, not shown, the backing 59 and the plate 52 are integrally formed or may be joined along the side and lower edges 61, 71 and 63, 73, such that the carrier 50 may receive the tool 10.

The carrier 50 is mounted directly on a belt or to an attachment provided on a belt (not shown), for example by threading a belt through the slots 57, or alternatively by fastening the plate 52 or the backing 59 to the belt or belt attachment. Preferably, the belt is formed of webbing or other sufficiently durable material, such that when worn, the lower portion 68 of the plate 52 stands away from the body, thus providing space between the lower portion 68 and the backing 59 to accommodate the neck 23 and strike face 22 of the double-headed tool 10, as shown in phantom lines in FIG. 8. The backing 59 protects the user from the strike face 22 when the tool 10 is inserted in the carrier 50.

To mount the tool 10 in the carrier 50, the strike face 22 and the neck 23 are passed through the expanded section 56 of the aperture 54, and then the tool is lowered so that the neck 23 engages the slot portion 55. The tool 10 is thus suspended from the carrier 50 by the neck 23 and the slot portion 55. The tool 10 may be disengaged from the carrier 50 by raising the neck 23 to a point where the strike face 22 may pass through the expanded portion 56 of the aperture 54.

Referring to FIGS. 1 and 9, in use as a striking tool, the user selects a head 20 or 30 for use as the striking head. For ease of reference, it is assumed that the head selected as the striking head is the first head 20, and the end of the handle 40 furthest from the striking head is the distal handle end 49, and the second head 30 is referred to as the counterweighting head 30. It will of course be understood that the role of the striking head and counterweighting head may be switched, and the striking head may be the second head 30 and the counterweighting head the first head 20. Once the user has selected a striking head, the tool 10 is preferably gripped at or around the distal handle end 49, as shown in FIG. 9, such that the strike face 32 of the counterweighting head 30 is directed towards the user's body; the user's thumb is therefore positioned along the handle 40 on the face nearest the neck 33. If, as in the embodiment shown in FIG. 1, the counterweighting head 30 is a claw-type hammer head or a similarly shaped head with a cheek 35 extending along the direction of the handle 40, the palm of the hand will rest on the cheek 35, and the outside of the hand is nested in the engagement surface 38 defined by the distal handle end 49 and the claw 36. A person skilled in the art will appreciate that if the second head 30 is shaped differently, for example, as a mallet head as shown in FIG. 6, the palm of the hand may not rest on the cheek 35, but rather along the distal end of the handle 49; and accordingly the outside of the hand will not be nested within the engagement surface 38.

The preferred grip is facilitated by the generally rectangular profile of the handle 40, which allows the user to determine by touch that the tool 10 is aligned properly within the hand. If the tool 10 is picked up by the user by means of the handle 40, the preferred grip can be located by allowing the handle 40 and the user's grasp to slide with respect to each other, until the engaging surface 38 of the counterweighting head 30 engages the user's hand. FIGS. 9a, 9b, and 9c illustrate a grasping action of the tool 10. If the tool 10 is suspended from the carrier 50 such that the counterweighting head 30 is engaged in the carrier 50, the preferred grip may be located if the tool 10 is removed from the carrier 50 by lifting it by the claw 36; the weight of the tool 10 causes the hand to engage the engaging surface 38.

When the tool 10 is used to strike a target, such as a fastener or working surface (not shown), it will be appreciated that the additional weight of the tool 10 due to the counterweighting head 30 provides the user with increased momentum for dealing blows or driving fasteners. As the position of the counterweighting head 30 is at or behind the fulcrum (the user's wrist), additional stress that would otherwise be placed on the user's wrist when swinging the tool 10 is reduced. Furthermore, it can be seen that the generally rectangular profile of the handle 40 in combination with the engagement surface 38, by providing an aligned grip on the tool 10, increases the amount of control exerted by the user when dealing a blow; there is reduced risk of glancing off the target, as the user is assured by the preferred grip that the tool 10 will swing in the intended direction, and will not rock or torque as the wrist is moved during the swing, unless the wrist itself is twisted during the swing. Therefore, the need to choke up on the striking tool 10 to deliver a first, less powerful blow to a fastener is reduced; the user can deal all blows to the fastener using the preferred grip at a consistent distance from the fastener, with increased likelihood of striking the “sweet spot” of the strike face 22. In addition, the added weight of the counterweighting head 30 tends to induce understrike, thus compensating a potential overstrike.

The counterweighting head further absorbs a portion of the reverberation felt throughout the tool 10 upon impact of the striking head, thus reducing stress on the user's joins and muscles.

In addition, because the first and second heads 20, 30 are oriented at a right angle to each other, the double-headed tool 10 may be easily picked up from a flat surface as one head 20 or 30 rests on either its striking face or claw, while the other head 30 or 20 rests on a side edge; this elevates the one end of the handle 40 above the working surface so that the user may reach under the handle 40 to grip it. The double-headed striking tool 10 is further more stable than the prior art, single-headed hammer when lying on the striking face or claw of one head 20, 30, as the other head 30 or 20 provides increased contact between the tool 10 and the working surface. By contrast, the prior art handle must be balanced on its face or claw and the edge of the handle end; there is therefore less contact area between the prior art hammer and the working surface, resulting in increased instability.

The enhanced stability of the double-headed tool 10 is also apparent when the tool is suspended from the first head 20, using the claw 26, over a panel, door, rafter, ladder rung, or the like. The second head 30, being aligned at a right angle to the first head 20, provides increased inertia and resists accidental displacement. This increased inertia due to the second head also provides another useful striking face on the heads 20, 30, on the upper face 21, 31.

A further feature of the double-headed tool 10 is its bi-directional nature. The counterweighting head 30, providing an engagement surface 38, eliminates the need for a flare or stop point at the end of the handle 40, as is often used with prior art hammers to prevent the hammer from slipping out of the user's grip. The counterweighting head 30 also eliminates the need for a tether strap for use in inclement weather.

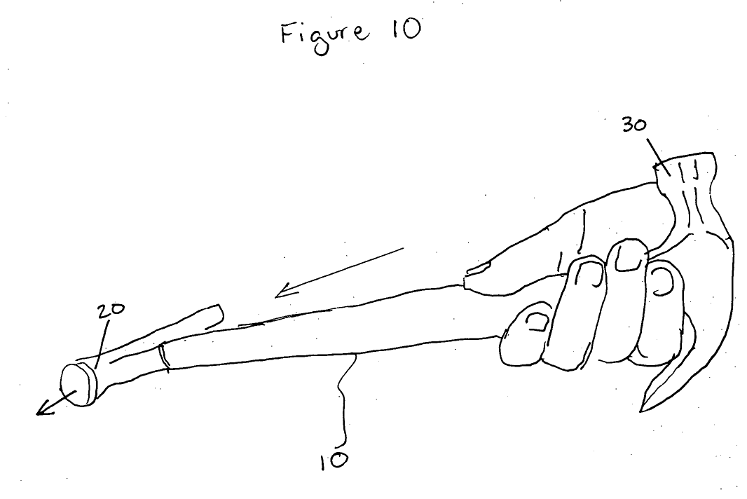

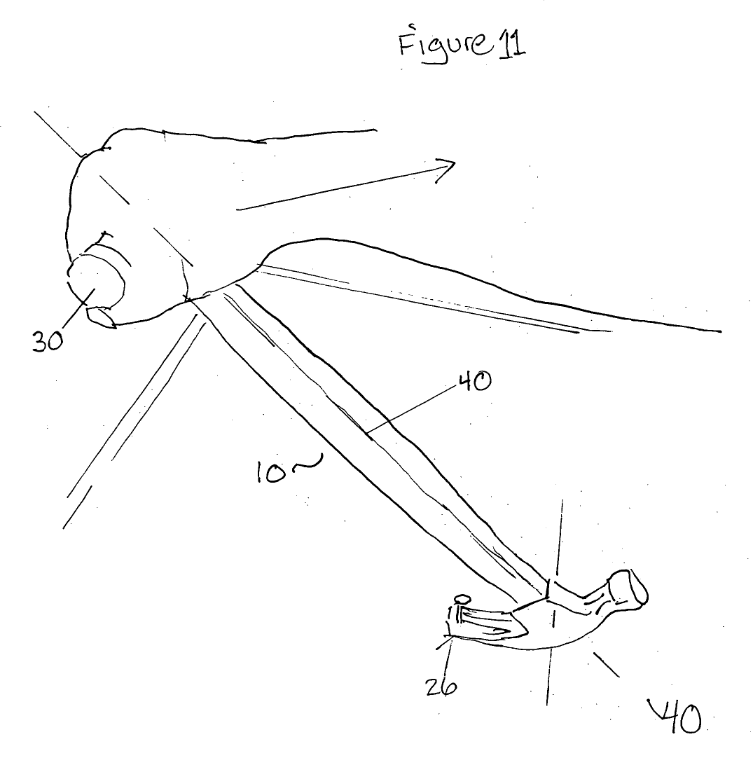

In the preferred embodiment in which the counterweighting head 30 is a claw-type hammer, or indeed in any embodiment where the end of the counterweighting head 30 nearest the outside of the hand extends beyond the outside of the hand, when gripped using the preferred grip shown in FIG. 9 the tool 10 provides protection for the hand, as the minimum clearance for using the tool 10 is the length of the counterweighting head 30, which is preferably greater than the width of the hand. Furthermore, because the angle of the counterweighting head 30 to the striking head 20 elevates the distal end of the hammer 49 when the hammer is placed on a horizontal surface, the double-headed tool 10 facilitates sideways blows dealt in close proximity to the horizontal surface, as shown in FIG. 10. The counterweighting head 30 continues to protect the hand as a blow is dealt.

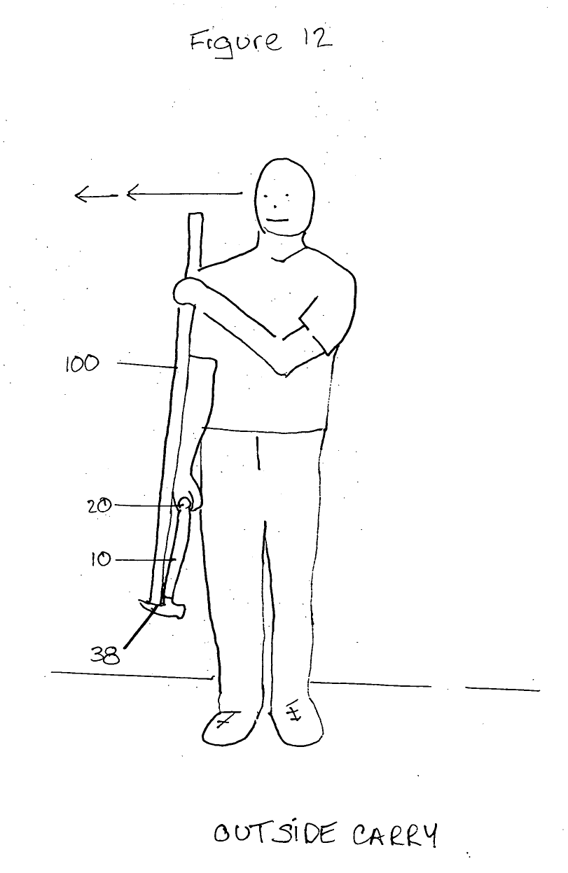

If at least one of the heads is provided with a claw for ripping fasteners, such as nails, out of a working surface, the alignment of the remaining head provides an improved grip for applying leverage to the fastener, as shown in FIG. 11. While, in FIG. 11, the claw 26 of the first head is positioned around the shank or head of the fastener in the conventional manner, rather than gripping the handle 40 of the tool 10, the user grips the head 30 and pulls the tool 10 away from the fastener. The position of the user's hand provides a greater range of movement than the hammers of the prior art, and reduces torque or twist on the claw 26 as the fastener is removed.

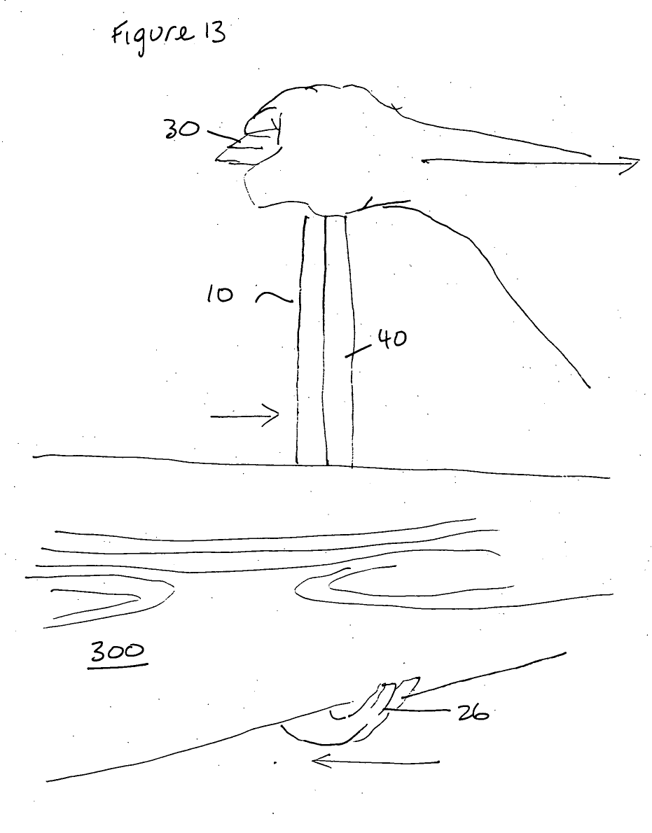

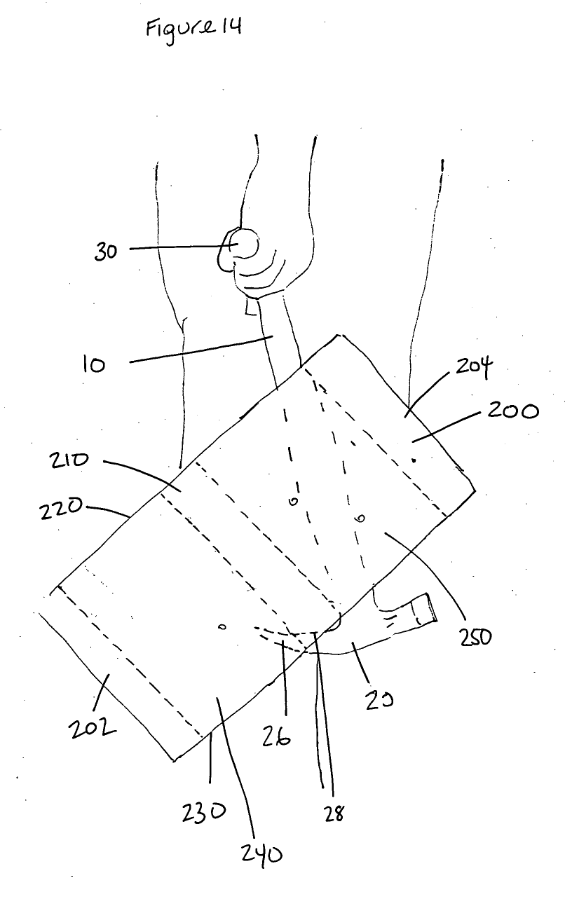

Again, if at least one of the heads is provided with a claw, the tool 10 may also serve as an arm extender or panel carrier. As shown in FIG. 12, a panel 100 of any width may be placed on the engagement surface 38 of a claw head, and the tool 10 carried using the remaining head 20, in a manner similar to that used for ripping fasteners out of a work surface. Depending on the height and width of the panel, the tool 10 may be used for an “inside carry” (not shown) wherein the upper portion of the panel is supported by the user's body, or by an “outside carry” (shown), wherein the upper portion of the panel may be further supported by the user's other hand. If the user's arm is fully extended, a tool 10 having a handle of approximately 16″ length may be used to transport a 48″ high panel, without obstructing the view of a male worker of average height. The double-headed tool 10, in addition to eliminating the need to carry an additional prior art hammer, thus also eliminates the need to carry a separate pry bar or drywall or panel carrier. A further application of the tool 10 as a carry aid is shown in FIG. 14, in which the tool 10 is employed to carry a concrete block or cinder block 200. As can be seen in FIG. 14 in phantom lines, the block 200 is generally hollow with walls 202, 204 and open faces 220 and 230, with a shelf 210 extended between the faces 220 and 230 to reinforce the structure. The block 200 is thus defined with at least one aperture 240 or 250, through which the tool 10 is passed so that the shelf provided with claw 26 of the tool 10 engages the shelf 210 or the wall 202 with the engagement surface 28.

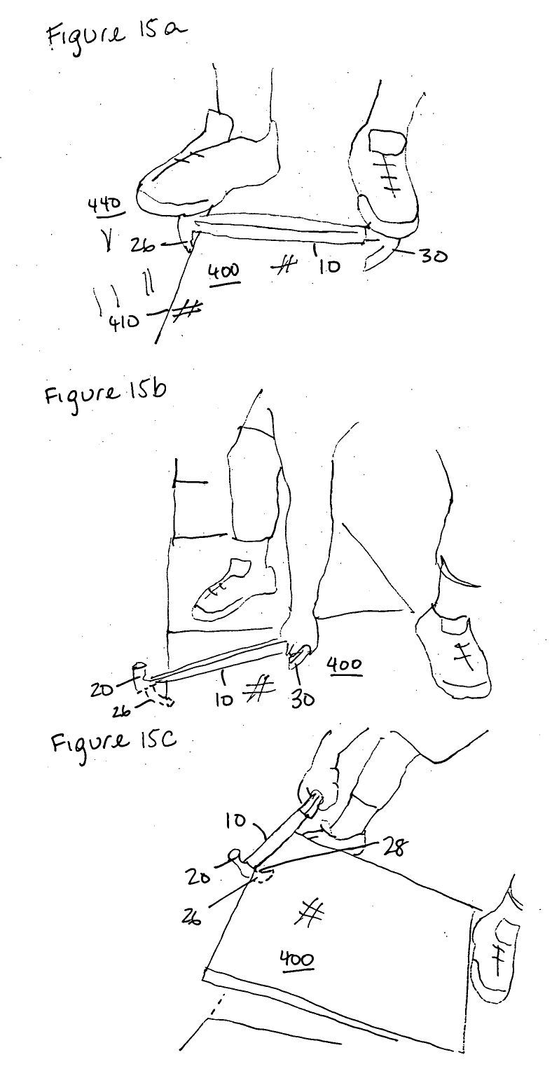

The double-headed tool 10, also when gripped as describe above as for ripping fasteners or carrying panels, may also be used for stud straightening work. As shown in FIG. 13, the handle 40 provides support for the face of the stud 300 as the gripped head 30 is pulled. The leveraging capabilities of the tool 10 may further be used to raise panels, patio stones, and the like that are partially embedded in the ground. FIGS. 15a, 15b, and 15c show a preferred method for raising a patio stone 400. In FIG. 15a, the claw 26 of the tool 10 is forced into the ground 440 surrounding the patio stone 400, such that the claw is adjacent the edge of the stone 410, while the distal end of the tool (the grip head 30) is held in place. In FIG. 15b, the grip head 30 is raised; the tool is pivoted along an axis such that the claw 26 is further driven below the edge of the patio stone 410. Finally, in FIG. 15c, the stone 400 is raised as the edge of the stone 410 is engaged by the engagement surface 28. The orientation of the grip head 30 in relation to the other head 20 assists the user in leveraging the stone 400.

As noted above, the two striking heads 20, 30 of the double-headed striking tool 10 may have different configurations according to their intended usage, thus eliminating the need to carry two separate, single-headed tools. Without limiting the generality of the present invention, the configurations of either of the heads 20, 30 may include the features of the striking heads of rock climbers', ball pein, riveting, magnetic tack, magnetic upholsterers', hand drilling, welders' chipping, blacksmiths', double-faced, lineman's', maul, double-faced sledge, rig builders', shingling, drywall, bricklayers', straight claw, curved claw, framers', rip claw, rawhide, copper, split, dead blow, soft face, nylon, plastic, rubber, pickaxe, prospecting, oyster, broad hatchet, drywall hatchet, and geological hammers. While a preferred material for hand tool handles for many users is wood, other materials including fibreglass, steel, and other materials known in the art may be employed. The heads and the handle may be formed integrally of a suitable material, such as steel, if suitable for the intended use of the tool.

As can be seen in FIG. 1, the preferred embodiment of the double-headed tool 10 may be used as a striking tool by employing one of eight possible surfaces: the strike faces 23, 33; the cheeks 25, 35 on either side of the head 20, 30; and the top surface 27, 37. If a double-faced head such as a mallet is selected for the heads 20, 30, then the tool 10 will have a total of ten possible striking surfaces. In a further embodiment, the tool 10 may be provided with a head that comprises a pick, such as the rock climbers' pick, which, while it is not provided with a substantially flat strike face like a typical framing or finishing hammer, is still provided with strike faces. In yet a further embodiment, the heads 20, 30 may be formed to as two opposing curved or rip claws, such as those formed in the head of a typical framing or finishing hammer; the tool 10 would thus be lacking the strike faces 20, 30 shown in FIG. 1, but may still be provided with cheeks 25, 35 for use as striking surfaces, in addition to four claws or engagement surfaces for use in prying or as a carry aid.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A striking tool, comprising:
a handle having an axis,
a first head mounted to a first end of the handle, and
a second head having substantially the same mass as the first head, opposedly mounted to a second end of the handle at a substantially right angle to the first head in a plane perpendicular to the axis of the handle.

2. The striking tool of claim 1 wherein the first end and the second end of the handle have substantially the same cross-sectional area, and the midpoint of the handle has a cross-sectional area greater than the cross-sectional area of either the first or second end.

3. The striking tool of claim 2 wherein the first end and the second end of the handle each have a cross-section defined by a longer dimension and a shorter dimensions such that the longer dimension of the first end of the handle is at a substantially right angle to the longer dimension of the second end.

4. The striking tool of claim 3, wherein the cross-section of the handle at the midpoint is substantially square, and the cross-section of the handle at each of the first end and second end is substantially rectangular.

5. The striking tool of claim 1 wherein at least one of the first head and the second head is provided with a strike face.

6. The striking tool of claim 1 wherein at least one of the first head and the second head is provided with a claw.

7. The striking tool of claim 1 wherein each of the first head and the second head is provided with a strike face and a claw.

8. The striking tool of claim 1 wherein each of the first head and the second head is provided with two opposedly-facing claws.

9. The striking tool of claim 1 wherein at least one of the first head and second head is provided with an engagement surface for engaging a grip while the other of the first head and second head is used for striking.

10. A hand tool, comprising:
a handle having an axis,
a first head adapted for striking mounted to a first end of the handle, and
a second head adapted for striking having substantially the same mass as the first head, opposedly mounted to a second end of the handle at a substantially right angle to the first head in a plane perpendicular to the axis of the handle.

11. The hand tool of claim 9 wherein at least one of the first head and second head is provided with an engagement surface for engaging a grip while the other of the first head and second head is used for striking.

12. (canceled)

13. (canceled)

14. (canceled)

15. (canceled)
